(19) United States
(12) Patent Application Publication
(10) Pub. No.: US 2005/0243024 A1
(43) Pub. Date: Nov. 3, 2005

(54) Line scanning in a display

(76) Inventors: Adrianus Sempel, Eindhoven (NL); Pieter Jacob Snijder, Eindhoven (NL); Remco Los, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/517,108

(22) PCT Filed: May 21, 2003
(86) PCT No.: PCT/IB03/02195

§ 371 Date: Dec. 7, 2004

(30) Foreign Application Priority Data
Jun. 11, 2002 (EP) 02077287.7

(51) Int. Cl. G09G 3/20

(52) U.S. Cl. 345/55

(57) ABSTRACT

The present invention is directed towards a method of scanning lines in a display and towards a display control device for scanning lines in a way which is less trackable by the human eye as well as towards an electronic device including such a display control device. The control device includes a line driving unit (18,20) and a control unit (22), which control unit (22) varies the selection of lines to be scanned and controls the line driving unit (18,20) to scan the selected lines. Selection and scanning is varied in such a way that energy variations caused by the scanning of lines is less trackable by the human eye. In this way bright lines or flickering normally caused by scanning of lines is reduced.

### TECHNICAL FIELD

The present invention is directed towards a method of scanning lines in a display, a display control device as well as an electronic device including such a display control device and more generally towards selection of rows or columns for scanning in displays.

### BACKGROUND OF THE INVENTION

In some types of displays, like in passive addressed organic LED matrix displays, when a row is to be illuminated during a flame, all the light is generated during the time the row is active or scanned. In a small amount of time a large peak brightness is then generated. If the display contains for example 100 rows, this leads to a row having 100 times greater brightness than the average brightness of the display.

In this type of display rows are normally scanned by consecutive row scanning, i.e. scanning all rows of the display, starting with the first and then sequentially scanning all the other rows ending with the last row of the display. This scanning is done within a time called a frame and scanning of the rows is repeated for each frame.

It is also known to use what is called interlaced scanning. Here, first all the even rows are scanned in growing order followed by scanning of all the odd lines in growing order from a first row to a last row of the display. This means that every other line is scanned during a first half of a frame and then the rest of the lines are scanned during the second half of the frame.

If a consecutive or interlaced row scanning order is used in a passive addressed organic LED matrix display, then rows are energized with a constant scanning speed. If a viewer watches the display from the corner of his eyes without focusing on the screen or the display is moved at a constant speed in the opposite direction to the scanning direction or if the human eye moves in the same direction as the scanning direction while viewing the display and this movement has the same speed as the scanning speed, a bright flashy line will appear to the eye, which is distressing to the observer. This problem arises because the light of activated pixels in consecutive lines stimulates the same nerves within the retina of the eye. This is also known as saccadic eye movement. The problem can also occur when a user is blinking. This problem can also be present in other types of displays, but is often most prominent in passive addressed organic LED matrix displays.

If the same type of line scanning is continually used for a number of consecutive frames another problem might arise for specific angle velocities of the eye. Possibly, no emissive pixel is observed at all during a number of frames, resulting in a perceived modulation of the luminance level between the average level and black. Especially when large parts of the picture are at the same luminance level, temporarily darker parts are observed when looking for a long period. The perception of this adding up of so-called black “off-pixels” differs from the perception of the adding up of bright “on-pixels”. These added up black “off-pixels” result in the perception of flicker by the eye.

U.S. Pat. No. 5,796,375 describes driving a display with different time periods for providing a certain luminance level. Here rows are scanned in consecutive order. The document also describes the division of the screen into a number of tiles, each comprising sixteen rows. The rows within a tile are scanned in successive order. In this way the different tiles or every sixteenth row of the display are scanned simultaneously, but in successive order. The document also describes reducing the flicker level of the display. Luminance levels for a pixel are normally provided during eight fields of data having different time periods in a frame, where the lowest intensity is provided in one time period and the highest in all eight. By displaying these fields in a non-progressive sequence, for instance in a random order, the flicker of the display is reduced. This reduction of a flicker level is thus related to the luminance level of a pixel and does not reduce the above-mentioned problems related to the scanning of a whole line of pixels such as the scanning of a row.

### SUMMARY OF THE INVENTION

The present invention is directed towards solving or at least reducing the above-mentioned problems associated with the piling up of black “off-pixels” causing flickering or the piling up of bright “on-pixels” causing bright lines at saccadic eye-movement, i.e. when the display is watched from the corner of the eye without focusing, or when the display is moved or the eye is moved during scanning of lines in the display. The invention is defined by the independent claims. The dependent claims define advantageous embodiments.

The problems are solved by a method of scanning lines in a display including the steps of selecting lines to be scanned, scanning the lines and varying selection and scanning of lines so as to reduce tracking by the human eye of energy variations caused by scanning. The problems are also solved by a display control device and an electronic device including such a display control device, the display control device comprising a line driving unit and a control unit. The control unit is arranged to vary selection of lines to be scanned and to control the line driving unit to scan the selected lines so as to reduce tracking by the human eye of energy variations caused by scanning. The display can be an organic LED display, as well as any other type of display which applies scanning in combination with a high peak-intensity ratio of pixels in relation to the average intensity to be displayed, such as a Field Emission Display (FED).

It is advantageous if the method further comprises the steps of selecting a line to be scanned during a frame of the display according to a non-consecutive selection criterion, scanning the selected line, continuing selecting other lines according to the non-consecutive selection criterion and scanning the other lines until at least a set of lines of the display have been scanned during the frame, wherein the non-consecutive selection criterion provides at least two different step sizes to be used when selecting lines within the set.

This first embodiment of the present invention is directed towards solving the problem with bright lines that appear during saccadic eye movement, i.e. when a display is watched from the corner of the eye without focusing, during scanning or energizing of a whole line of pixels or when the display is moved or the eye is moved during scanning.

It is also advantageous if the method further comprises the steps of selecting a first selection criterion for a first frame, using said criterion for the first frame, selecting a second selection criterion for a second frame and using said second criterion for the second frame so that line selection and scanning is varied between frames.

The second embodiment is directed towards solving the problem of piled up black off-pixels, which makes the eye perceive flickering at saccadic eye movement, i.e. when the display is watched from the corner of the eye without focusing, or which appears when the display is moved or the eye is moved during scanning or energizing of a whole line of pixels.

The problems are also solved by a display control device comprising a line driving unit and a control unit, wherein the control unit is arranged to vary selection of lines to be scanned and to control the line driving unit to scan the selected lines so as to reduce tracking by the human eye of energy variations caused by scanning. The control device can be an electronic unit, circuitry or one or more integrated circuits with or without peripheral components.

It is advantageous if the control unit is arranged to choose a first non-consecutive selection criterion, use said first criterion during at least a first frame, choose a second non-consecutive selection criterion and use said second criterion during at least a second frame so that line selection and scanning is varied between frames. This embodiment is directed towards solving the same problem as the second embodiment.

The idea of the invention is to provide line scanning which is not trackable by the human eye, so that irritating bright lines or other flickering normally caused by line scanning is avoided.

The expression line used here is intended to comprise lines in any direction on the display, i.e. either in row or column direction.

The above mentioned and other aspects of the invention will be apparent from and elucidated with reference to the embodiments described hereinafter.

### BRIEF DESCRIPTION OF THE DRAWINGS

The present invention will be further described in relation to the accompanying drawings, in which:

FIG. 1 shows an electronic device according to the invention,

FIG. 2 shows a block schematic of a display control device according to the invention,

FIG. 3 shows a first division of a display into a set of rows for explaining the principle of a first embodiment of the invention,

FIG. 4 shows a second division of a display into different sets of rows for explaining the principle of an alternative embodiment of the first embodiment of the invention,

FIG. 5 shows a flow chart of a method according to the first embodiment.

FIG. 6 shows a side view of an LCD layer and a backlighting layer of a display,

FIG. 7 shows a block schematic of a display control device for backlighting a display, and

FIG. 8 shows a flow chart of a method according a second embodiment of the invention.

### DETAILED DESCRIPTION OF THE INVENTION

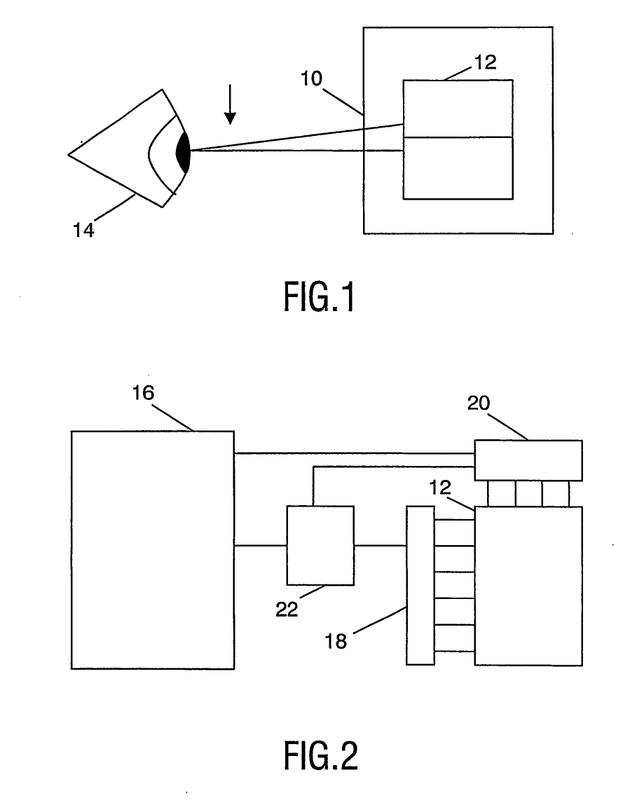

In FIG. 1 is shown an electronic consumer device 10 in the form of a cellular phone provided with a display 12, which preferably is a passive addressed organic LED matrix display. The organic LED display can be a small molecule or polymer LED matrix display. A user looks at the scanned line of a display with an eye 14. When the user looks at the screen of the device 10 with saccadic eye movement, i.e. from the corner of the eye without focusing, or when he blinks or watches the display while either moving the display or the eye with constant speed, he will not be able to track a flashing line when applying the scanning scheme according to the invention as will be elucidated below. In the Figure, the user moves his eye in the normal scanning direction, which is indicated by means of an arrow.

FIG. 2 shows a block schematic of a display control device according to the invention. The display control device includes an image memory 16 containing data about how each pixel of a display is to be displayed. The content of the image memory is decided by such things as functions activated by the user and different types of input from a user as well as a general layout of the screen, and is well known within the art. This information can include such things as color and brightness. The device furthermore includes a first line driving unit in the form of a column driving unit 20 connected between the image memory 16 and the display 12. The device also includes a second line driving unit in the form of a row driving unit 18 connected to the display 12. There is furthermore a timing and control unit 22 connected to the image memory 16, the column driving unit 20 and the row driving unit 18. The timing and control unit is preferably provided in the form of a processor with associated program memory containing program code for providing the row selection scheme. As mentioned before, the image memory 16 includes data about how all pixels of the display are to be displayed. The image memory receives this information from other parts of the phone in a manner well known within the art, for instance from the receiving part of a mobile phone, television receiver, or the information is inputted in correct form from any input device. All pixels are energized once per frame. This is done through the timing and control unit 22 controlling the image memory 16 to submit data about each row of pixels to the column driving unit 20 and then provide the row driving unit 18 with signals selecting rows for scanning. When a row is selected the column driving unit 20 applies a pixel pattern received from the image memory 16 to the columns and the row is scanned or energized so that the pixels are lit. How this is done is largely well known in the art and will not be further described here. What is not well known however is the way in which rows are selected, which is the subject of a first embodiment of the present invention.

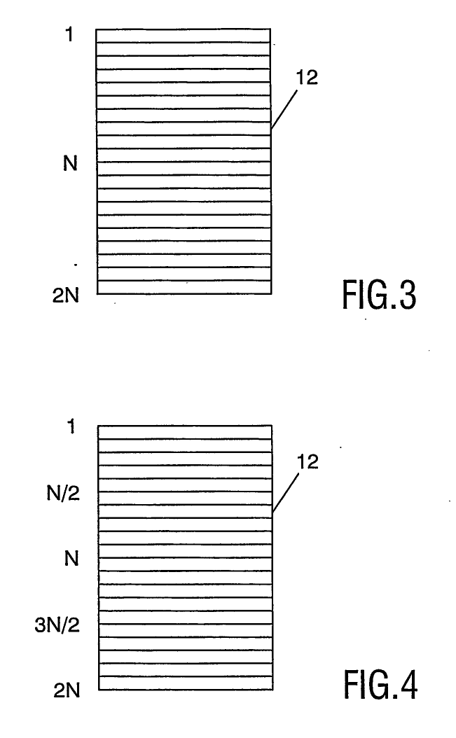

The first embodiment of the invention will now be described in relation to FIG. 3, which shows the rows of the display 12. The display typically has 2N rows, where N can be for instance 50. The display can therefore be seen as containing a set of rows consecutively numbered from 1 to 2N. According to one of the known scanning techniques, the rows would be scanned in sequence from row no. 1 to row no. 2N, without skipping a row. The distance between consecutively selected rows would then be constant. According to the first embodiment another way of row selection is used. First a row in the middle of the display, row no. N, is chosen and then scanned. Thereafter rows N−1 and N+1 are selected and scanned by subtracting the scanned row in the downward direction by one and adding the scanned row in the upward direction by one. Thereafter rows are scanned with alternating growing and diminishing orders until all rows have been scanned within a frame. In this way a non-consecutive scanning scheme has been provided, i.e. rows are not selected in a consecutive order for scanning. The distance between sequentially selected rows also differs, i.e. the distance between the rows selected after each other changes. This can also be seen as a way to vary the scanning step size between sequentially selected rows. In this way selection and scanning of rows has been varied such that the scanning of rows is not trackable by the human eye. There is also a constantly changing scanning direction, which makes that the eye is not able to track the flashes. The user is thus unable to notice the flashes emerging because of the scanning of a line when the eye is moved or the display is moved at saccadic eye movement. In this example the number of flashes that add up in the eye during constant movement at the critical speed is halved.

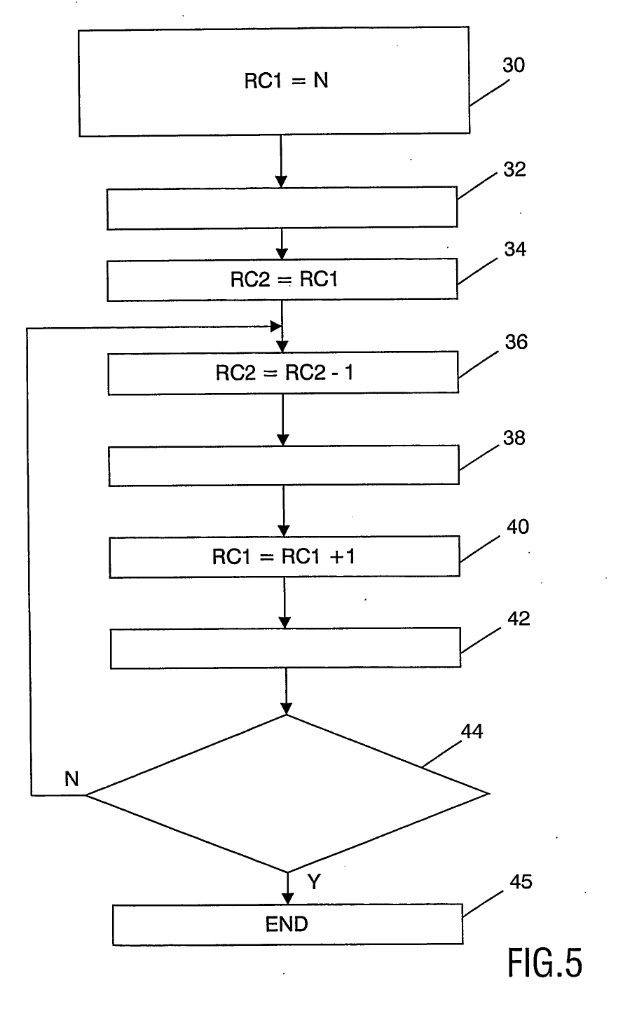

A method for scanning rows according to the first embodiment, which is also considered to be a preferred mode to practice the invention, will now be explained in relation to FIG. 5. When a set of 2n rows has to be scanned, the method involves the following steps:
In step 30 a first row counter RC1 is set to a value N,
In step 32 the row N is scanned.
In step 34 a second row counter RC2 is set to the value of the first row counter RC1, so to the value N.
In step 36 the value of the second row counter RC2 is set to its previous value −1.
In step 38 the row corresponding to the value of the second row counter RC2 is scanned.
In step 40 the first row counter RC1 is set to its previous value +1.
In step 42 the row corresponding to the value of the first row counter RC1 is scanned.
In step 44 is checked whether all rows of the set have been scanned:
If not, indicated by N, then step 36 up to and including 44 are repeated.
If yes, indicated by Y, the method is ended, indicated by END, in step 45.

The method can then be repeated for all consecutive frames starting with step 30. In the above-mentioned scheme, there is a non-consecutive scanning scheme, i.e. the rows selected for scanning are not consecutive rows. Step sizes between the consecutively or sequentially selected rows thus differ. In this way selection and scanning of rows has been varied such that the scanning of rows is not trackable by the human eye. There are thus different distances or step sizes between sequentially selected rows, i.e. between the rows selected after each other, and also different scanning directions, i.e. scanning is alternately performed in an upward and a downward direction.

With the described embodiment, there is a chance that two successive rows coincide with the constant movement of the eye or display as described above. However the piled up brightness is halved, which reduces the problem.

Thus a preferred embodiment of the invention has been described. However, there are many ways in which the invention can be varied. One first variation of the first embodiment of the present invention will now be described in relation to FIG. 4. In this so called split screen display the display is divided into two sets of rows, where the first set starts with row 1 and ends with row N and the second set starts with row N+1 and ends with row 2N. The above-described method of selecting rows is performed for each set of rows, either serially or in parallel. This would mean that row N/2 would be scanned first in the first set followed by alternating scanning of lower and higher order rows until rows 1 and N have been scanned. In the same way row 3N/2 would be scanned first in the second set followed by alternating scanning of lower and higher order rows until rows N+1 and 2N have been scanned in the second set. Serial selection is to taken to mean in the method that first the first set of rows is scanned followed by scanning of the second set of rows. Parallel scanning is to be taken to mean that the scanning of rows in the second set is done simultaneously with that of rows in the first set. Simultaneous scanning can also be done in such a way that when a row is scanned in the direction towards lower order numbers in the first set a row is scanned in the direction of higher order numbers in the second set at the same time. All rows are scanned however within the same frame. It is possible to scan with more different sets of rows arranged in parallel.

There are several more ways in which the first embodiment of the present invention can be varied. It is possible to use a completely random row selection. Here the timing and control unit would include a random number generator for selecting non-scanned rows for scanning. In this case there might exist the same step size between a few selected rows, but there will be at least two different step sizes used between different rows.

It is furthermore possible to use other types of scanning orders. There can be a scanning order where the distance between the rows when scanning in a direction is doubled. For instance, scanning could be done of rows 1, 2, 4, 8, 16, 32, 64 etc. up to row 2N and then the same type of scheme would be used for scanning in the backward direction. The scheme is repeated for all non-scanned rows within a frame until all the rows have been scanned. The scheme can of course also be used for two or more sets of rows in the same way as described above, either for addressing serially or in parallel. It is also possible to combine the two different directions, in that the upward and downward scanning can be performed alternately in a manner similar to what was described in the first embodiment. It is also possible to scan if the distance between scanned rows has another growth order, like for instance tripling of the distance between the scanned rows.

A further variation is to scan a first group of consecutive rows, for instance, rows 1, 2 and 3 followed by scanning of a second group of rows, for instance rows 7, 8 and 9 and by scanning of a third group of rows, for instance 4, 5 and 6, etc. Here there is one first step size between the rows within a group and another step size between the last row of a group and the first row of a following group. This means that the selection criterion provides at least two different step sizes for consecutively selected rows. In one embodiment there are also varying step sizes between the different groups of rows.

Naturally each one of these three last-mentioned variations of the first embodiment can be combined with a split screen scanning.

These are just a few of all types of scanning schemes that can be used. The important thing is that it is not possible to track the scanned rows, which might occur with simple display movements or simple eye movements, or during saccadic eye movement. In this way there are varying distances and varying step sizes between consecutively scanned rows, so that a user cannot see a line movement when watching the display from the corner of the eye. There are also provided at least two different step sizes for selecting rows to be scanned within a set of rows for each selection criterion.

The problem described above is most prominent when the display is showing non-moving pictures with many pixels lit. In a black-and-white display this would mean that many pixels were showing the color white. However, the effect is also visible for lower intensities, for instance with a gray background instead or when other colors are displayed.

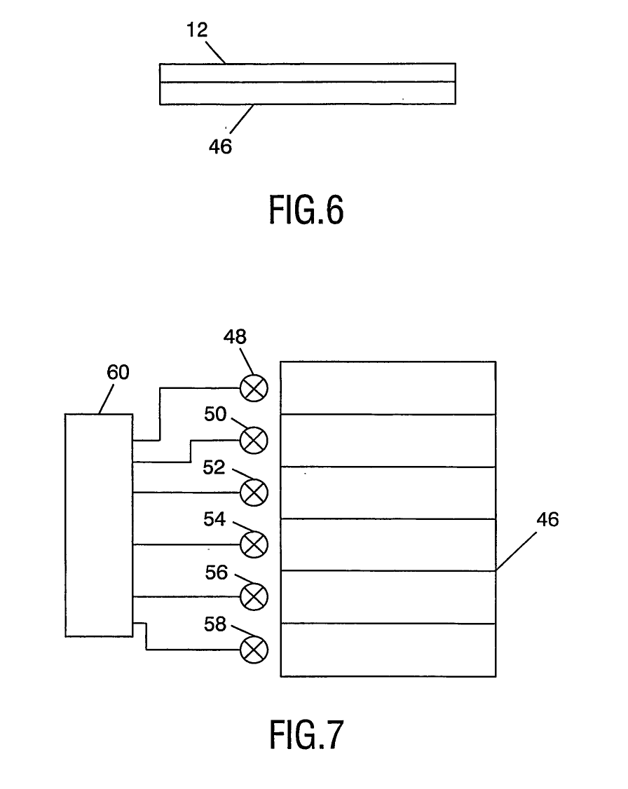

The present invention according to the first embodiment can also be used for varying the backlighting used for a display. FIG. 6 shows a side view of a display in a cellular phone provided with an LCD layer 12 provided on top of a transparent backlighting layer 46. In the LCD layer information is displayed according to the principles described earlier. The backlighting layer 46 is provided for lighting up the display for instance when the environment in which the display is used is dark.

In FIG. 7 is shown a block schematic of a device for scanning lines for backlighting a display. Here the backlighting layer 46 is divided into a number of segments, such that each segment can be seen as forming a line to be lit up by a lamp. In FIG. 7 there are six lamps 48, 50, 52, 54, 56 and 58 in the form of light emitting diodes. It is evident that other types of lamps are possible instead. There is also a control unit 60 connected to the lamps, which controls the scanning of the lines. This control unit is a combined control and line driving unit.

If the display is to be backlit, the control unit 60 selects lines to be scanned according to a non-consecutive selection criterion, for instance according to any of the ones described earlier. All the lines are scanned during a frame. In this way the lines are not scanned in a consecutive order that can be followed by the eye.

In the embodiment described, the control unit for backlighting differs from the timing and control unit used for the LCD layer. It can however be the same control unit. Naturally there can also be more or fewer than six lamps. The principle can furthermore be used for front-lit displays as well.

The first embodiment of the invention and the variations mentioned thus avoid the possibility that bright scanned lines are detected by the eye.

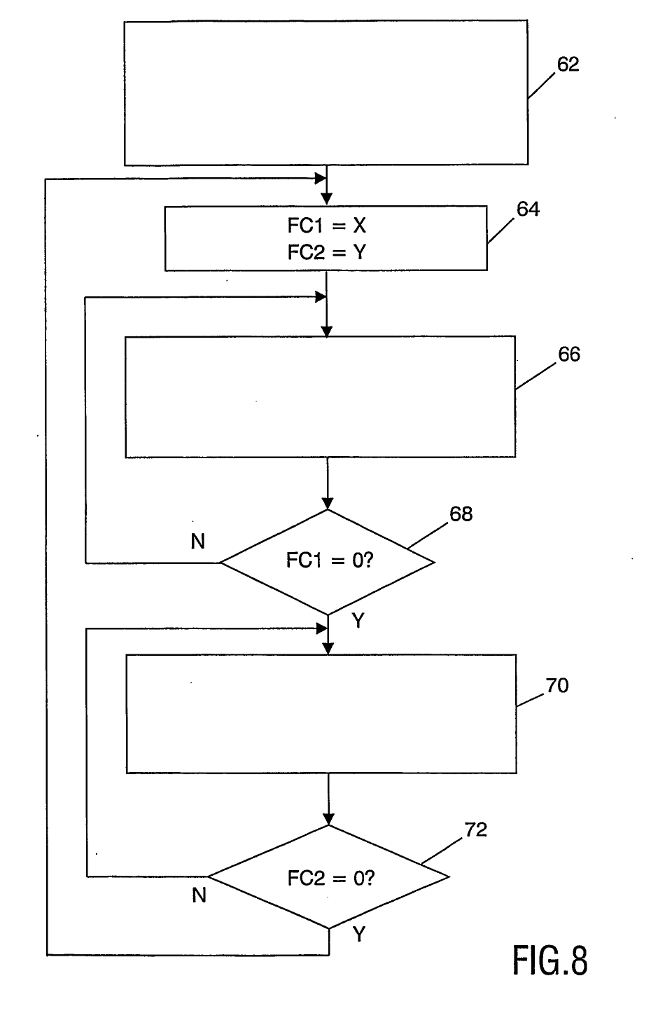

In a second embodiment of the present invention, different row scanning schemes are provided for different frames. During a first frame a first scheme is used, for instance the described preferred scheme. During a second frame another scheme is used, for instance the scheme described above with doubled distances between scanned rows. In this way switching between several different scanning schemes can be performed for different frames. Said switching can be performed for each frame; one scheme can be used for a number of frames followed by another scheme for a few other frames etc. The possible variations of this switching are countless. In this case the timing and control unit keeps track of when to switch between schemes. This second embodiment will be described in more detail in relation to FIG. 8, which shows a flow chart of the method in question. The device used for performing this method is the device in FIG. 2.

First the timing and control unit selects a first row selection criterion to be used for a first number of frames X and a second row selection criterion to be used for a second number of frames Y, step 62. The numbers are preferably equal, but this is not necessary. The numbers can furthermore differ considerably from one frame up to tens or hundreds of frames. Thereafter a first frame counter FC1 is set to the selected number of frames X for which the first criterion is to be used and a second frame counter FC2 is set to the selected number of frames Y for which the second criterion is to be used by the timing and control unit, step 64. Thereafter the timing and control unit selects rows according to the first criterion, makes the row driving unit scan the selected rows during a first one of the frames and decreases the first frame counter FC1 by one, step 66. If the first frame counter FC1 has not reached zero, step 68, the selection and scanning according to the first criterion is continued, step 66. If FC1 has reached zero, step 68, the timing and control unit switches selection criterion to the second row selection criterion, selects rows according to this criterion, makes the row driving unit scan the thus selected rows during a first frame and decreases the second frame counter, FC2 by one, step 70. If FC2 has not reached zero, step 72, the timing and control unit continues selecting rows according to the second criterion and continues making the row driving unit scan these selected rows, step 70. If FC2 has reached zero, step 72, the timing and control unit again sets FC1 and FC2 to the originally set values, step 64, and continues running through steps 66-72.

There are a number of possible variations of this second embodiment of the invention. The schemes selected are preferably the ones used according to the first embodiment of the invention. This is however not necessary. Other schemes are possible, like for instance interlaced and continuous row selection. It is furthermore possible to alternate between more than two different criteria. Finally it is also possible to change selections of criteria and the number of frames during which a criterion is to be used after scanning has started.

It is furthermore possible to vary the second embodiment of the invention in the following way. Different selection criteria can be used depending on data content or mode of operation. For example one criterion can be used when text is scrolled, another when graphics is to be displayed and perhaps yet another criterion is used when the display is in stand-by mode.

With this second embodiment and the variations mentioned, detection of flickering because of piled up black “off-pixels” is avoided.

The present invention is not limited to use in combination with passive matrix organic LED matrix displays, but can be used in any type of display with high peak brightness of the pixels. Examples of other types of displays are PDP, OLED, EL, and CRT. The second embodiment and variations thereof can furthermore be provided in combination with an Active Matrix Address LCD display with scanning backlight, where the number of black light sequences is increased.

The invention is furthermore not limited to electronic devices like cellular phones, but can be implemented in any type of electronic device such as palmtops, laptop computers, electronic game machines, TVs and standard computers. The electronic device can also be a display module comprising the display, the line driving unit and the control unit. Finally, it is equally well possible to use the same type of scanning for columns instead of rows.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, a number of these means can be embodied by one and the same item of hardware. The mere fact that certain measures are recited in mutually different dependent claims does not indicate that a combination of these measures cannot be used to advantage.

1. Method of scanning lines in a display, the method including the steps of
selecting lines to be scanned,
scanning the lines and
varying selection and scanning of lines so as to reduce tracking by a human eye of energy variations caused by scanning.

2. Method according to claim 1, further including:
selecting a line to be scanned during a frame of the display according to a non-consecutive selection criterion,
scanning the selected line,
continuing selecting other lines according to the non-consecutive selection criterion, and
scanning the other lines until at least a set of lines of the display have been scanned during the frame,
wherein the non-consecutive selection criterion provides at least two different step sizes to be used when selecting lines within the set.

3. Method according to claim 2, wherein the set of lines comprises a set of consecutive lines of the display less than all lines of the display.

4. Method according to claim 2, wherein the set of lines includes all lines of the display.

5. Method according to claim 2, wherein the non-consecutive selection criterion comprises selecting a line in between the first and the last line and thereafter alternately selecting a lower order line and a higher order line relative to the first selected line until all lines of the set of lines have been scanned.

6. Method according to claim 2, comprising the step of changing the scanning direction between at least some sequentially selected lines within the set.

7. Method according to claim 2, wherein the step sizes are varied between sequentially selected lines or groups of lines.

8. Method according to claim 2, wherein the non-consecutive selection criterion comprises a randomized selection of not-yet-scanned lines.

9. Method according to claim 3, further including a second set of lines also including a first and a last line, and the steps of selecting, continuing selecting and scanning are performed on the second set of lines.

10. Method according to claim 9, comprising the step of changing the scanning direction between at least some sequentially selected lines within the sets.

11. Method according to claim 9, wherein the non-consecutive selection criterion comprises selecting a line in between the first and the last line of the first set and thereafter alternately selecting a lower order line and a higher order line relative to the first selected line until all lines of the first set have been scanned and selecting a line in between the first and the last line of the second set and thereafter alternately selecting a lower order line and a higher order line relative to the first selected line of the second set until all lines of the second set of lines have been scanned.

12. Method according to claim 11, wherein a lower order line in the first set is selected simultaneously with a higher order line in the second set and a higher order line in the first set is selected simultaneously with a lower order line in the second set.

13. Method according to claim 9, wherein the non-consecutive selection criterion comprises separate randomized selection of not-yet-scanned lines within each set.

14. Method according to claim 1, comprising selecting a first selection criterion for a first frame, using said criterion for the first frame, selecting a second selection criterion for a second frame and using said second criterion for the second frame so that line selection and scanning is varied between frames.

15. Display control (1) comprising:
a line driving unit and
a control unit,
wherein the control unit is arranged to vary selection of lines to be scanned and to control the line driving unit to scan the selected lines so as to reduce tracking by a human eye of energy variations caused by scanning.

16. Device according to claim 15, wherein the control unit is arranged to select lines to be scanned during a frame of the display according to a non-consecutive selection criterion and to control the line driving unit to scan the selected lines of the display until at least a set of all the lines of the display has been scanned during the frame, and wherein the non-consecutive selection criterion provides at least two different step sizes to be used when selecting lines within the set.

17. Device according to claim 15, wherein the control unit is arranged to choose a first non-consecutive selection criterion, use said first criterion during at least a first frame, choose a second non-consecutive selection criterion and use said second criterion during at least a second frame so that line selection and scanning is varied between frames.

18. An electronic device including a display and a display control device, wherein the display control device comprises:
a line driving unit and
a control unit,
wherein the control unit is arranged to vary selection of lines to be scanned and to control the line driving unit to scan the selected lines so as to reduce tracking by a human eye of energy variations caused by scanning.
